(19) United States
(12) Patent Application Publication
(10) Pub. No.: US 2014/0069623 A1
(43) Pub. Date: Mar. 13, 2014

(54) METHOD OF MANUFACTURING HEAT DISSIPATING BASE, HEAT DISSIPATING BASE AND HEAT DISSIPATING DEVICE

(71) Applicant: COOLER MASTER DEVELOPMENT CORPORATION, New Taipei City (TW)

(72) Inventor: Chia-Yu Lin, New Taipei City (TW)

(73) Assignee: COOLER MASTER DEVELOPMENT CORPORATION, New Taipei City (TW)

(21) Appl. No.: 13/968,446

(22) Filed: Aug. 16, 2013

(30) Foreign Application Priority Data
Sep. 10, 2012 (TW) 101132997

(51) Int. Cl. B23P 15/26; F28F 3/02

(52) U.S. Cl. CPC B23P 15/26; F28F 3/02
USPC 165/185; 29/890.03

(57) ABSTRACT

A method of manufacturing a heat dissipating base includes steps of providing a first base, wherein the first base is made of a first heat conducting material; putting the first base into a mold; pouring a second heat conducting material, which is melted, into the mold, wherein a thermal conductivity of the first heat conducting material is larger than that of the second heat conducting material; and processing the second heat conducting material by a die casting process, so as to form a second base, wherein the second base covers a periphery of the first base and an upper surface and a lower face of the first base are exposed.

### BACKGROUND OF THE INVENTION

1. Field of the Invention

The invention relates to a method of manufacturing a heat dissipating base, a heat dissipating base and a heat dissipating device and, more particularly, to a heat dissipating base formed by a die casting process using two heat conducting materials with different thermal conductivities.

2. Description of the Prior Art

Heat dissipating device is a significant component for electronic products. When an electronic product is operating, the current in circuit will generate unnecessary heat due to impedance. If the heat is accumulated in the electronic components of the electronic product without dissipating immediately, the electronic components may get damage due to the accumulated heat. Therefore, the performance of heat dissipating device is a significant issue for the electronic product.

In a conventional heat dissipating device, heat pipes or heat dissipating fins are disposed a copper base and the copper base is attached on an electronic component. Heat generated by the electronic component is conducted to the heat pipes or the heat dissipating fins through the copper base. In general, the electronic component is always attached to the center of the copper base, such that the periphery of the copper base does not work well on heat dissipation. If the whole base is made of copper only, the manufacturing cost of the heat dissipating device will increase.

### SUMMARY OF THE INVENTION

The invention relates to a heat dissipating base capable of reducing the manufacturing cost effectively and the heat dissipating base is formed by a die casting process using two heat conducting materials with different thermal conductivities, so as to solve the aforesaid problems.

According to an embodiment of the invention, a method of manufacturing a heat dissipating base comprises steps of providing a first base, wherein the first base is made of a first heat conducting material; putting the first base into a mold; pouring a second heat conducting material, which is melted, into the mold, wherein a thermal conductivity of the first heat conducting material is larger than a thermal conductivity of the second heat conducting material; and processing the second heat conducting material by a die casting process, so as to form a second base, wherein the second base covers a periphery of the first base and an upper surface and a lower face of the first base are exposed.

According to another embodiment of the invention, a heat dissipating base comprises a first base and a second base. The first base is made of a first heat conducting material. The second base is formed by a die casting process using a second heat conducting material, which is melted during the die casting process. The second base covers a periphery of the first base, an upper surface and a lower face of the first base are exposed, and a thermal conductivity of the first heat conducting material is larger than a thermal conductivity of the second heat conducting material.

According to another embodiment of the invention, a heat dissipating device comprises a heat dissipating base and a plurality of heat dissipating members. The heat dissipating base comprises a first base and a second base. The first base is made of a first heat conducting material. The second base is formed by a die casting process using a second heat conducting material, which is melted during the die casting process. The second base covers a periphery of the first base, an upper surface and a lower face of the first base are exposed, and a thermal conductivity of the first heat conducting material is larger than a thermal conductivity of the second heat conducting material. The heat dissipating members are disposed on the heat dissipating base.

As mentioned in the above, the first heat conducting material (i.e. the first base) with large thermal conductivity is covered by the second heat conducting material (i.e. the second base) with small thermal conductivity in the die casting process, so as to form the heat dissipating base. After forming the heat dissipating base, the first base with large thermal conductivity is located at the center of the heat dissipating base and the upper and lower surfaces thereof are exposed. The first base of the heat dissipating device can be attached to an electronic component, such that heat generated by the electronic component can be conducted to the heat dissipating members on the heat dissipating base through the first base. For example, the invention may use copper with large thermal conductivity to form the first base and use aluminum with small thermal conductivity to form the second base, so as to reduce the manufacturing cost of the heat dissipating base effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a heat dissipating device according to a first embodiment of the invention.

FIG. 2 is a schematic view illustrating the heat dissipating base shown in FIG. 1.

FIG. 3 is a schematic view illustrating the heat dissipating base shown in FIG. 2 in another viewing angle.

FIG. 4 is a cross-sectional view illustrating the heat dissipating base along line X-X shown in FIG. 2.

FIG. 5 is an exploded view illustrating the heat dissipating base shown in FIG. 2.

FIG. 6 is an exploded view illustrating the heat dissipating base shown in FIG. 3.

FIG. 7 is a flowchart illustrating a method of manufacturing the heat dissipating base shown in FIG. 2.

FIG. 8 is a schematic view illustrating a heat dissipating device according to a second embodiment of the invention.

### DETAILED DESCRIPTION

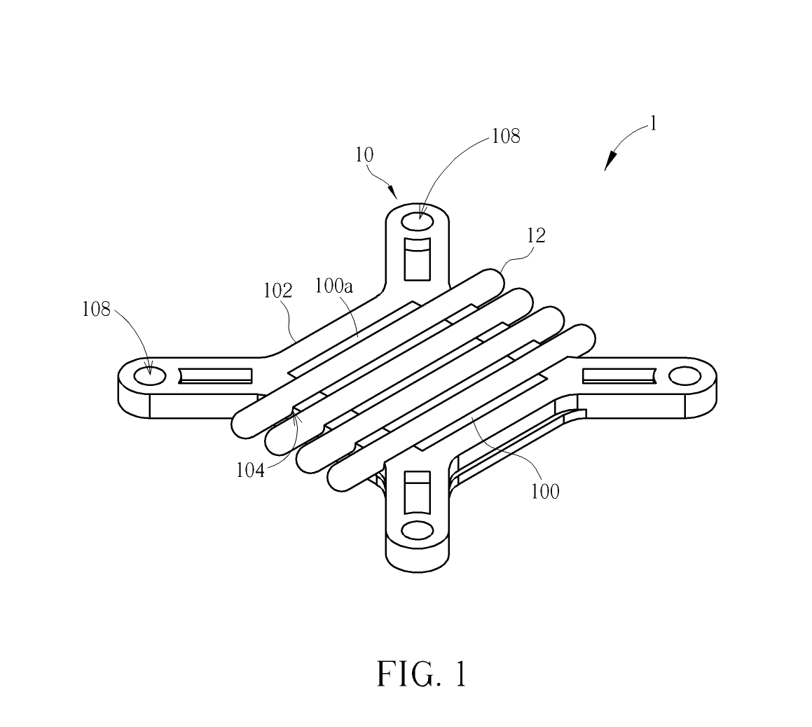

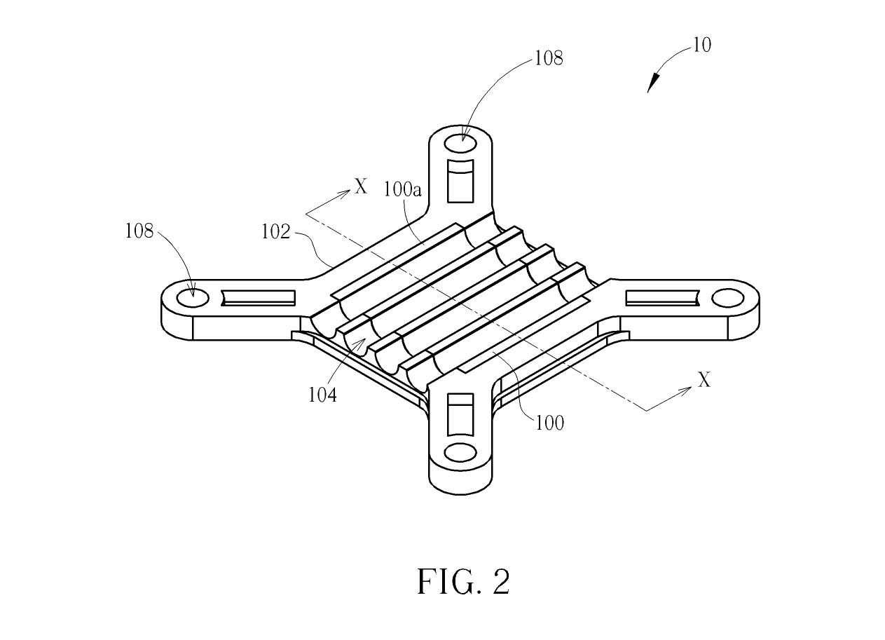

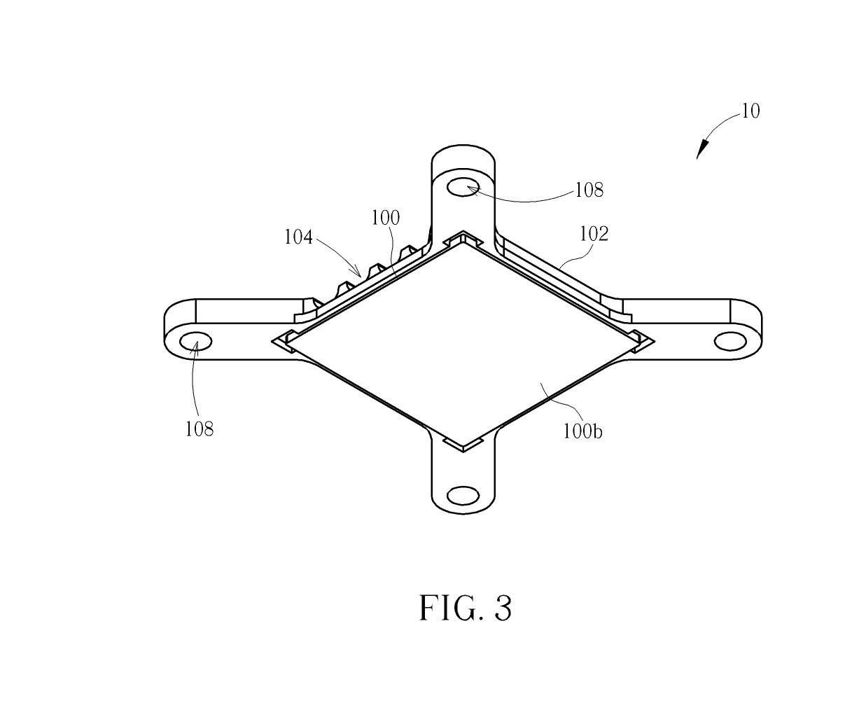

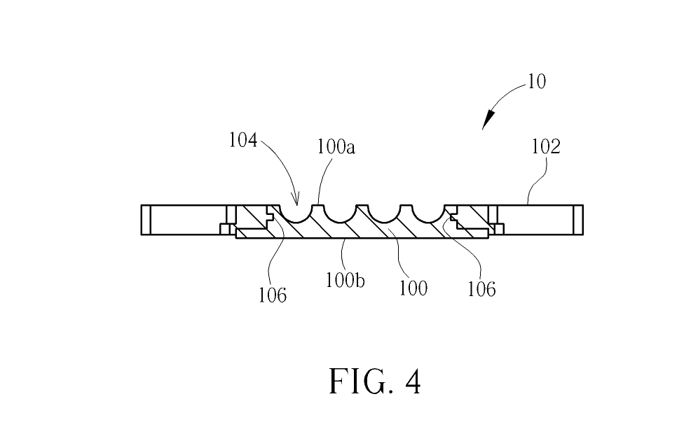

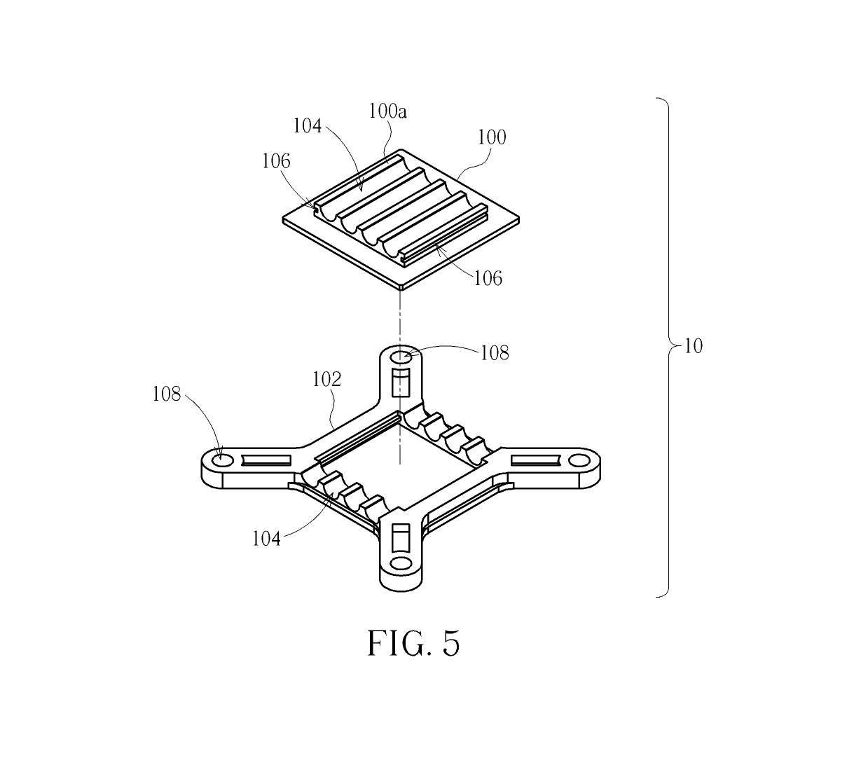

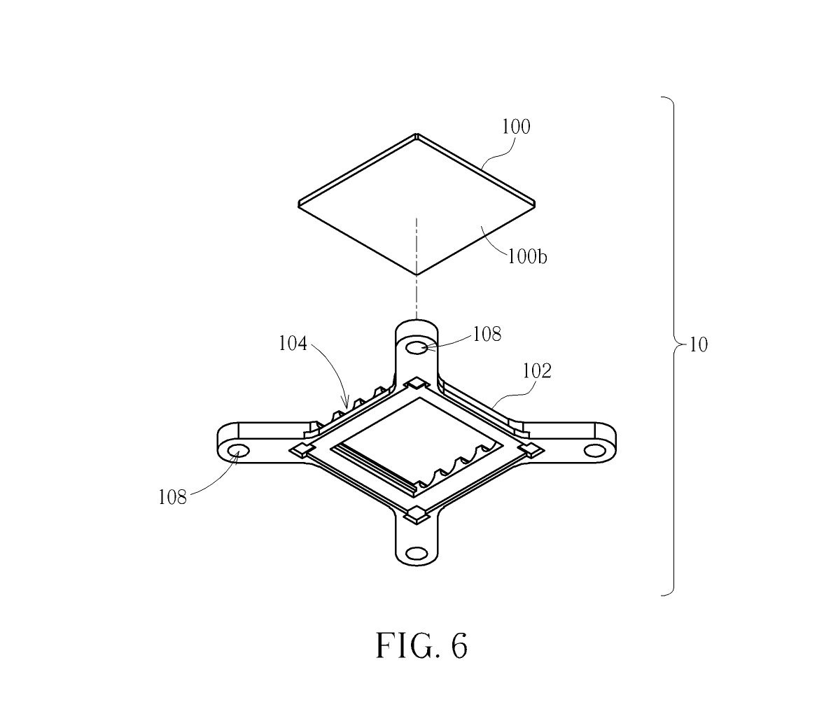

Referring to FIGS. 1 to 6, FIG. 1 is a schematic view illustrating a heat dissipating device 1 according to a first embodiment of the invention, FIG. 2 is a schematic view illustrating the heat dissipating base 10 shown in FIG. 1, FIG. 3 is a schematic view illustrating the heat dissipating base 10 shown in FIG. 2 in another viewing angle, FIG. 4 is a cross-sectional view illustrating the heat dissipating base 10 along line X-X shown in FIG. 2, FIG. 5 is an exploded view illustrating the heat dissipating base 10 shown in FIG. 2, and FIG. 6 is an exploded view illustrating the heat dissipating base 10 shown in FIG. 3. As shown in FIG. 1, the heat dissipating device 1 comprises a heat dissipating base 10 and a plurality of heat dissipating members 12, wherein the heat dissipating members 12 are disposed on the heat dissipating base 10. In this embodiment, the heat dissipating members 12 are heat pipes.

As shown in FIGS. 1 to 6, the heat dissipating base 10 comprises a first base 100 and a second base 102. The first base 100 is made of a first heat conducting material. The second base 102 is formed by a die casting process using a second heat conducting material, which is melted during the die casting process. The second base 102 covers a periphery of the first base 100, an upper surface 100a and a lower face 100b of the first base 100 are exposed, and a thermal conductivity of the first heat conducting material is larger than a thermal conductivity of the second heat conducting material. In other words, after forming the heat dissipating base 10, the first base 100 with large thermal conductivity is located at the center of the heat dissipating base 10 and the upper and lower surfaces 100a, 100b thereof are exposed. The first base 100 of the heat dissipating device 1 can be attached to an electronic component (not shown) , such that heat generated by the electronic component can be conducted to the heat dissipating members 12 on the heat dissipating base 10 through the first base 100.

In this embodiment, the aforesaid first heat conducting material may be copper (the thermal conductivity of copper is about 400 W/mK) and the aforesaid second heat conducting material may be aluminum (the thermal conductivity of aluminum is about 200-250 W/mK). Although the thermal conductivity of aluminum is smaller than that of copper, the cost of aluminum is much lower than that of copper. Therefore, since the heat dissipating base 10 is formed by the die casting process using aluminum (i.e. the second base 102) to cover copper (i.e. the first base 100), the manufacturing cost can be reduced effectively. Since the electronic component is attached to the first base 100 with large thermal conductivity, which is located at the center of the heat dissipating base 10, heat generated by the electronic component can be conducted to the heat dissipating members 12 through the first base 100 effectively. In other words, the second base 102, which covers the periphery of the first base 100, will not influence the heat dissipating effect of the heat dissipating base 10.

In this embodiment, a plurality of fixing grooves 104 is formed on a side of the first base 100 and the second base 102 and used for fixing the heat dissipating members 12. For example, the heat dissipating members 12 may be fixed in the fixing grooves 104 by soldering, engaging structures or other fixing manners. Furthermore, the periphery of the first base 100 has an engaging structure 106, such that the engaging structure 106 can be engaged with the second base 102 during the die casting process, so as to strengthen the connection between the first base 100 and the second base 102. In this embodiment, the engaging structure 106 is a groove. However, in another embodiment, the engaging structure 106 may also be a saw-toothed structure, a wave-shaped structure or other structures capable of strengthening the connection between the first base 100 and the second base 102 according to practical applications. Moreover, the invention may use a specific mold in the die casting process to form a plurality of fixing holes 108 on the second base 102. In practical applications, screws or other fixing members (not shown) may be inserted into the fixing holes 108, so as to fix the heat dissipating base 10 on a plane where the electronic component is located at.

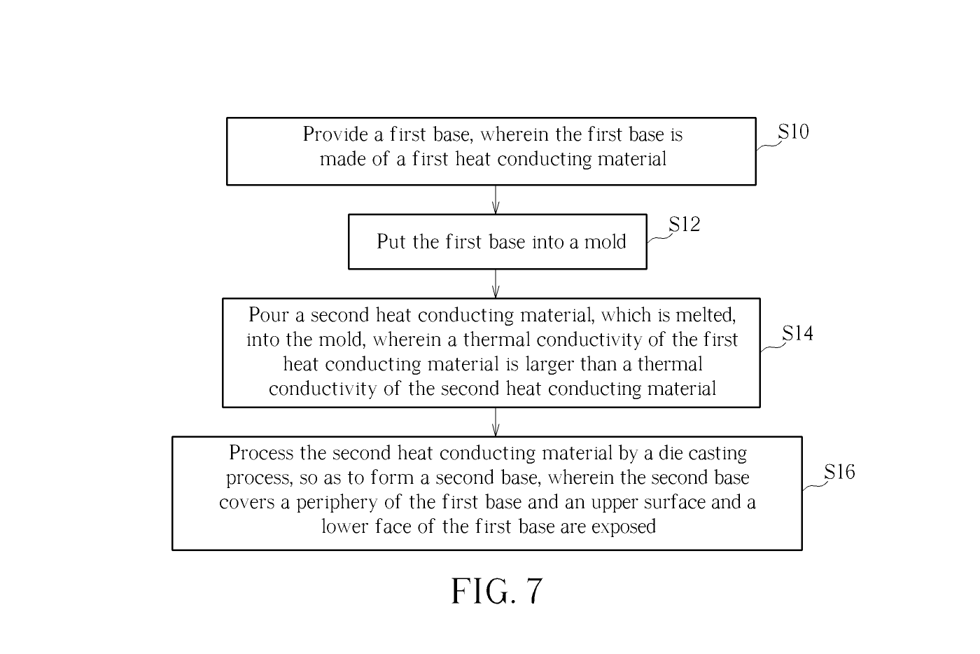

Referring to FIG. 7, FIG. 7 is a flowchart illustrating a method of manufacturing the heat dissipating base 10 shown in FIG. 2. First of all, step S10 is performed to provide a first base 100, wherein the first base 100 is made of a first heat conducting material (e.g. copper). Afterward, step S12 is performed to put the first base 100 into a mold (not shown). Step S14 is then performed to pour a second heat conducting material (e.g. aluminum), which is melted, into the mold, wherein a thermal conductivity of the first heat conducting material is larger than a thermal conductivity of the second heat conducting material. Finally, step S16 is performed to process the second heat conducting material by a die casting process, so as to forma second base 102, wherein the second base 102 covers a periphery of the first base 100 and an upper surface 100a and a lower face 100b of the first base 100 are exposed. It should be noted that the aforesaid mold may be designed according to the desired appearance of the heat dissipating base 10. Furthermore, the structure and feature of the first base 100 and the second base 102 are mentioned in the above, so those will not be depicted herein again.

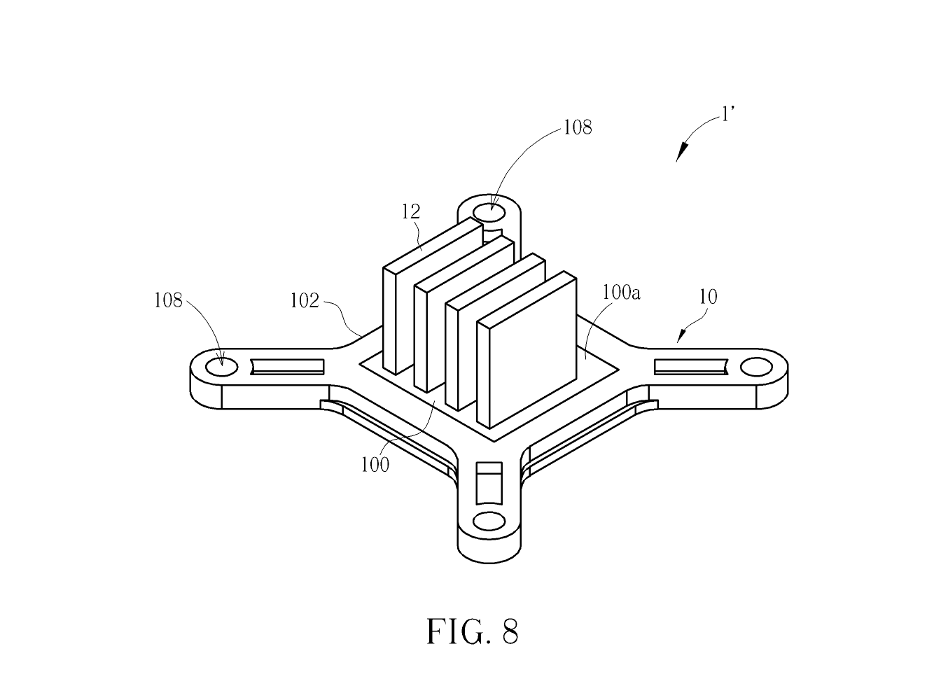

Referring to FIG. 8 along with FIG. 1, FIG. 8 is a schematic view illustrating a heat dissipating device 1′ according to a second embodiment of the invention. The difference between the heat dissipating device 1′ and the aforesaid heat dissipating device 1 is that the heat dissipating base 10 of the heat dissipating device 1′ does not has the aforesaid fixing grooves 104 and the heat dissipating members 12 are heat dissipating fins fixed on the first base 100. For example, the heat dissipating members 12 may be fixed on the first base 100 by soldering, engaging structures or other fixing manners or, alternatively, the heat dissipating members 12 may be formed with the first base 100 integrally by the die casting process according to practical applications. It should be noted that the same elements in FIG. 8 and FIGS. 1 to 6 are represented by the same numerals, so the repeated explanation will not be depicted herein again.

Compared with the prior art, the first heat conducting material (i.e. the first base) with large thermal conductivity is covered by the second heat conducting material (i.e. the second base) with small thermal conductivity in the die casting process, so as to form the heat dissipating base. After forming the heat dissipating base, the first base with large thermal conductivity is located at the center of the heat dissipating base and the upper and lower surfaces thereof are exposed. The first base of the heat dissipating device can be attached to an electronic component, such that heat generated by the electronic component can be conducted to the heat dissipating members on the heat dissipating base through the first base. For example, the invention may use copper with large thermal conductivity to form the first base and use aluminum with small thermal conductivity to form the second base, so as to reduce the manufacturing cost of the heat dissipating base effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing a heat dissipating base comprising steps of:
providing a first base, wherein the first base is made of a first heat conducting material;
putting the first base into a mold;
pouring a second heat conducting material, which is melted, into the mold, wherein a thermal conductivity of the first heat conducting material is larger than a thermal conductivity of the second heat conducting material; and
processing the second heat conducting material by a die casting process, so as to form a second base, wherein the second base covers a periphery of the first base and an upper surface and a lower face of the first base are exposed.

2. The method of claim 1, wherein the first heat conducting material is copper and the second heat conducting material is aluminum.

3. The method of claim 1, wherein the periphery of the first base has an engaging structure and the engaging structure is engaged with the second base during the die casting process.

4. The method of claim 3, wherein the engaging structure is a groove.

5. The method of claim 1, wherein a plurality of fixing grooves is formed on a side of the first base and the second base.

6. The method of claim 1, wherein a plurality of fixing holes is formed on the second base.

7. A heat dissipating base comprising:
a first base made of a first heat conducting material; and
a second base formed by a die casting process using a second heat conducting material, which is melted during the die casting process, the second base covering a periphery of the first base, an upper surface and a lower face of the first base being exposed, a thermal conductivity of the first heat conducting material being larger than a thermal conductivity of the second heat conducting material.

8. The heat dissipating base of claim 7, wherein the first heat conducting material is copper and the second heat conducting material is aluminum.

9. The heat dissipating base of claim 7, wherein the periphery of the first base has an engaging structure and the engaging structure is engaged with the second base during the die casting process.

10. The heat dissipating base of claim 9, wherein the engaging structure is a groove.

11. The heat dissipating base of claim 7, wherein a plurality of fixing grooves is formed on a side of the first base and the second base.

12. The heat dissipating base of claim 7, wherein a plurality of fixing holes is formed on the second base.

13. A heat dissipating device comprising:
a heat dissipating base comprising:
a first base made of a first heat conducting material; and
a second base formed by a die casting process using a second heat conducting material, which is melted during the die casting process, the second base covering a periphery of the first base, an upper surface and a lower face of the first base being exposed, a thermal conductivity of the first heat conducting material being larger than a thermal conductivity of the second heat conducting material; and
a plurality of heat dissipating members disposed on the heat dissipating base.

14. The heat dissipating device of claim 13, wherein a plurality of fixing grooves is formed on a side of the first base and the second base, and the heat dissipating members are heat pipes fixed in the fixing grooves.

15. The heat dissipating device of claim 13, wherein the heat dissipating members are heat dissipating fins fixed on the first base.

16. The heat dissipating device of claim 13, wherein the first heat conducting material is copper and the second heat conducting material is aluminum.

17. The heat dissipating device of claim 13, wherein the periphery of the first base has an engaging structure and the engaging structure is engaged with the second base during the die casting process.

18. The heat dissipating device of claim 17, wherein the engaging structure is a groove.

19. The heat dissipating device of claim 13, wherein a plurality of fixing holes is formed on the second base.
